(19) United States
(12) Patent Application Publication
(10) Pub. No.: US 2026/0273800 A1
(43) Pub. Date: Sep. 17, 2026

(54) DISC AGGLOMERATOR WITH DIRECT CONNECTION

(71) Applicant: Johannes Wissing, Stadtlohn (DE)

(72) Inventor: Johannes Wissing, Stadtlohn (DE)

(21) Appl. No.: 18/850,698

(22) PCT Filed: Mar. 23, 2023
(86) PCT No.: PCT/EP2023/057569

§ 371 Date: Dec. 16, 2024

(30) Foreign Application Priority Data
Mar. 25, 2022 (DE) 10 2022 107 068.9

(51) Int. Cl. B29B 17/00; B29B 17/04

(52) U.S. Cl. CPC B29B 17/0036; B29B 17/0412; B29B 2017/046

(57) ABSTRACT

The invention relates to a system for agglomerating and comminuting recycled plastic, comprising an agglomerator which is designed to receive plastic waste and form same into elongated pin-shaped or sausage-shaped agglomerates in a pasty state and which is designed in the form of a disc agglomerator, comprising two discs which are profiled on the mutually facing surfaces thereof, can be moved relative to each other, and are arranged parallel and at a distance to each other and between which a disc intermediate area is formed. The agglomerator has an inlet opening for the recycled plastic, said opening leading into the central region of the disc intermediate area, and an outlet opening for the agglomerates in the Outer circumference of the disc intermediate area. According to the invention, a housing runs about the exterior of the discs of the disc agglomerator in an annular manner and has a housing opening which adjoins a conveyor line, wherein a rotating disc of the disc agglomerator is designed to have a conveying effect so as to act on the agglomerates and guide same into the conveyor line under pressure, and the conveyor line leads to a device for further processing the agglomerates.

The invention relates to a system according to the preamble of claim 1.

Systems of the type in question are known from practice. For example, a disk agglomerator is disclosed in EP 2 817 131 B 1 in which plastic waste is processed to form elongated material strands which are subsequently comminuted so that small bodies are produced therefrom. In the context of the present proposal, both the plastic waste which is designed to be recycled in the disk agglomerator and the agglomerates generated in the disk agglomerator are denoted as recycled plastic.

These small bodies can be used later as raw material in the plastic processing industry, for example there is the possibility of processing them further in an extruder.

A disk agglomerator is disclosed in DE 41 18 858 in which the agglomerates are guided directly into the inlet of an extruder. The extruder is located at a distance below the lower circumferential portion of the disk agglomerator and the agglomerates fall freely out of the disk agglomerator through a shaft-like inlet which is arranged above the extruder. The functions pre-agglomerating, pre-compressing or pre-compacting upstream of the extruder take place in the disk agglomerator itself.

The object of the invention is to improve a system of the type in question such that it permits the processing of plastic waste with little effort in terms of energy and cost-efficiency.

This object is achieved by a system as claimed in claim 1. Advantageous embodiments are described in the dependent claims.

In other words, the invention proposes to transfer the agglomerated material strands, which emerge from the outlet opening of the disk agglomerator and gravitate radially outwardly, directly from the disk agglomerator into a conveying device and not only into the inlet thereof. A housing runs about the exterior of the two disks of the disk agglomerator in an annular manner and has a housing opening. Adjoined to this housing opening is a conveyor line which leads to a downstream processing device, for example to an extruder. The agglomerates are thus not initially collected and temporarily stored, wherein they are cooled, but are directly processed further so that they do not have to be brought back to the desired processing temperature for further processing. By means of the proposed system it is possible to reduce the energy expenditure of initially cooling the agglomerates, if required, in order to prevent them sticking together and then heating them up to the processing temperature. The agglomerates are present as elongated material strands when they emerge from the disk agglomerator on the external circumference radially outwardly between the two disks. Since the agglomerates have a slightly sticky surface due to their temperature, they tend to form a heap of irregularly arranged material strands attached together, which cannot be drawn by a screw conveyor or extruder screw into the housing thereof and which also in a short time prevents the inflow of further agglomerates since the heap forms a blockage.

The two disks of the disk agglomerator can be moved relative to each other, for example by different rotational speeds and/or rotational directions, if both disks are rotatable, or by one disk, denoted as a stator, being stationary and the other disk, denoted as a rotor, being rotatably driven. The invention is based on the consideration that either the kneading bars on the rotor disk of the disk agglomerator or the optionally present comminuting tools, which have a conveying effect and which serve for comminuting the elongated agglomerates, convey the agglomerates to the outlet opening, additionally assisted by the pressure which results from the inflowing material in the disk intermediate area and by the centrifugal force which acts on the agglomerates due to a rotating disk of the disk agglomerator.

In one embodiment, the conveying efficiency of a rotating disk of the disk agglomerator can be brought about by the design of the elements thereof which are otherwise present, for example by a corresponding shaping and arrangement of the kneading bars and/or comminuting tools. In a further embodiment, the disk can have conveying members, i.e. elements which are separately provided and which serve only for material conveyance and bring about or assist the conveying efficiency of the disk.

In one embodiment of the system, it can be provided to comminute the agglomerates into small bodies. In a disk agglomerator, either the gap opening which results from the distance between the two disks, i.e. a slot or gap running in an annular manner between the two disks corresponding to the disk circumference, or an opening in a housing surrounding the two disks functions as an outlet opening. For example, the comminuting of the material strands can take place by means of a ring comminutor, i.e. with a plurality of comminuting tools which are arranged on a circle and are closely adjacent to one another radially inside or outside the outlet opening and thus are downstream of the disk agglomerator in the direction of flow of the recycled plastic. The agglomerated material strands which emerge from the outlet opening of the disk agglomerator accordingly come into contact with the comminuting tools and are comminuted into shorter pieces, namely into the desired small bodies.

As a result, it is not necessary to convey the material strands through an additionally provided conveying device to a comminuting device which is located at a distance from the disk agglomerator. The energy required for this conveying device can thus be saved, in addition to the advantages in terms of energy which can be achieved in any case according to the proposal. Moreover, the material strands which are not yet cooled and relatively softer are directly comminuted at the outlet of the disk agglomerator so that the energy expenditure required for this comminuting is lower than the energy expenditure which might be required for the subsequent comminuting of the same material strands, but which are cooled and thus harder, which means a further advantage in terms of energy. Finally a particularly compact embodiment of the system is also achieved.

The comminuting tools can be arranged, for example, directly on a disk of the disk agglomerator or they can be mounted on a separately provided ring which is thus denoted as a comminuting ring.

In one embodiment of the system, the comminuting ring can be adjustable in the axial direction of the ring agglomerator, i.e. substantially transversely to the plane of the two disks, so that in the axial direction the comminuting ring opens up or closes to different extents the outlet opening circulating in an annular manner, i.e. the gap width of the outlet opening can be made narrower or wider. An adjustment of the gap width of the outlet opening is probably of less importance in the ongoing continuous operation of the ring agglomerator. However, firstly it provides the possibility of adapting the gap width to different recycled plastics to be processed so that the comminution can be set in a simple manner to the respective optimal gap width of the outlet opening in different industrial sites in which different types or compositions of recycled plastics are processed.

Secondly, however, in particular when starting up the system after an interruption in operation, this possibility of axial adjustment provides the advantage firstly of setting the outlet opening of the ring agglomerator to be small with a corresponding gap width, or even of closing the outlet opening completely and only gradually enlarging the gap width as the operating period of the disk agglomerator increases. Such an adjustable comminuting ring can thus also be denoted as a start-up ring. When starting up the ring agglomerator, initially only a small amount of recycled plastic is present between the two disks and, depending on the material used, it can arise that initially imperfect, flake-like agglomerates are produced instead of the desired agglomerated material strands, said agglomerates impeding further processing in systems which are downstream of the agglomerator. As the outlet opening can be reduced or even completely closed, the dwell time of the material in the disk agglomerator can be extended until it results in the formation of the desired material strands.

The enlargement of the outlet opening can be undertaken, for example, according to internal empirical values, for example after a specific time. Alternatively, it can be provided to enlarge the outlet opening automatically, by the comminuting ring being moved, for example, by motor, for example as a function of the current consumption when the disk agglomerator is driven by means of an electric motor and the current consumption reaches a specific value due to a higher rotational resistance which is present between the disks. This can be an absolute value, i.e. a specific current of X amperes.

The specific value, however, can also be a relative value which results, for example, from the progression of the current consumption over time. For example, the current consumption can rise as the filling level increases, when increasingly more recycled plastic passes into the intermediate area between the two disks. If less material per time unit emerges from the outlet opening and flows into the intermediate area as recycled plastic, it leads to such an increase in recycled plastic in the intermediate area since the outlet opening is partially or completely closed. Due to the higher filling level and the longer dwell time, the material in the disk agglomerator is treated more intensively and reaches higher temperatures due to the external influences and the internal friction.

The softening of the material associated therewith leads to a reduction in the rotational resistance of the disk agglomerator so that the current consumption of the drive motor at least does not increase further and typically even decreases again. If the current consumption is monitored by means of an electronic system control, an enlargement of the outlet opening can be automatically brought about, on the basis of the progression of the current consumption, by drive means of the comminuting ring being automatically activated and the comminuting ring being moved automatically in the axial direction. Now the agglomerated material located in the disk agglomerator can leave the disk agglomerator through the outlet opening in the form of the desired material strands which are comminuted in the comminuting ring into the desired shorter pieces.

Depending on the embodiment of the disk agglomerator and its outlet opening, the possibility of closing the outlet opening of the disk agglomerator entirely or partially during the start-up phase can be achieved by an axial adjustment of the two disks to one another, by an adjustable start-up ring—with or without comminuting tools—or by a movable slide or similar closure elements closing the outlet opening.

In a manner known per se, the disk agglomerator can be designed such that both disks do not rotate, but rather one disk is stationary. This disk, denoted as the stator, has the inlet opening through which the recycled plastic passes into the intermediate area between the two disks. The other disk, denoted as the rotor, is rotatably mounted and driven. In this embodiment, the comminuting ring can be held fixedly in terms of rotation on the stator. In initial practical tests, it has been shown that an excellent comminuting action can be achieved even when the comminuting ring is stationary, since the agglomerated material strands are entrained by the rotor and perform a relative movement not only in the radial direction but also in the direction tangential to the stator and accordingly also to the comminuting ring, so that the comminuting tools can act on the material strands.

In principle it can be provided that the comminuting tools simply form an abutment with which the material strands emerging from the disk agglomerator come into contact, so that they are sheared off and comminuted in this manner. In one embodiment, the comminuting tools can be designed as blades so that the comminuting of the material strands can take place with as little resistance as possible and thus requires as little energy as possible.

The blades can be advantageously arranged at an angle of between 350 and 80° relative to the axis of the agglomerator, which relates to the cutting edge of the blades. This results in a pulling cut which is advantageous in terms of energy and is also advantageous regarding the mechanical stress on the blades. Regarding these two aspects, in an embodiment which is regarded as advantageous, the angle at which the cutting edges of the blades are oriented to the axis of the agglomerator can be between 45° and 60°.

In one embodiment, the blades can be arranged in each case alternately in the ring comminutor. This permits a rapid and uncomplicated replacement of individual worn blades, or even the replacement of one or all of the blades by those with a differently designed cutting edge, if required.

In one embodiment, the blades can be arranged in each case in a blade holder which is replaceably held on the ring comminutor. A replacement of individual blades or all of the blades is also enabled thereby, as explained above. The blade holder can also be designed as a stable element so that a narrow delicate blade does not need to be handled separately. For example, the blade holder, which can have a greater material thickness than the blade itself, permits a screw fastening of the blade to the ring comminutor with a high tightening torque of the fastening screw without impairing the blade.

Irrespective of whether the blades are fixed to the ring comminutor directly or by means of a blade holder, in one embodiment the blades can be adjustably mounted in the radial direction. In this manner, the gap width of the ring gap, which is produced between the outlet opening and the blades, can be set in order to influence in this manner the size of the shorter pieces generated.

In one embodiment, a plurality of receivers which are designed to receive comminuting tools can be present on the comminuting ring, by the blades themselves or the blade holders provided with the blades being able to be held in the receivers, for example. In this embodiment, the comminuting ring can have such a large number of receivers that in many practical applications a corresponding number of blades is not required. Accordingly, in this embodiment of the system not all receivers are provided with a comminuting tool. The number of comminuting tools used can be varied according to the recycled plastic used or the desired size of shorter pieces into which the agglomerated material strands are intended to be comminuted.

In this embodiment, the receivers which are not required and accordingly not provided with a comminuting tool are covered by a cover element. In this manner, the receivers themselves are protected, for example, from contamination which potentially would impede a subsequent mounting of a comminuting tool in this receiver. In terms of avoiding accidents, protection for personnel is also achieved by an embodiment of the system with a surface being able to be made as smooth as possible and a rough outer surface of the comminuting ring being avoided.

In one embodiment, it can be provided that the ring comminutor not only has a series of comminuting tools which are arranged in an annular manner on the stator of the disk agglomerator, but rather in each case a row of comminuting tools arranged in an annular manner on both disks so that the agglomerated material strands, which emerge radially outwardly from the outlet opening, are comminuted into the short pieces by a shearing movement between the two different rows of comminuting tools. The system accordingly has first comminuting tools which are arranged on a first circle with a first diameter and are connected to a first disk of the disk agglomerator, and the system has second comminuting tools which are arranged on a second circle with a second diameter and are connected to a second disk of the disk agglomerator. The first and second comminuting tools can be moved relative to each other since the two disks of the disk agglomerator can be moved relative to each other. The diameters of the first and second circles are different so that the first and second comminuting tools cooperate in the manner of scissors and comminute the agglomerated material strands therebetween.

In this described embodiment of the system, it can be provided that the first and second comminuting tools are arranged in each case on a holding ring which is connected to the respective first and second disk of the disk agglomerator. The two holding rings have in each case a free space which is designed as an annular groove in which the comminuting tools, which are arranged on the respective other holding ring, can be immersed when the comminuting tools are adjusted in the axial direction of the disk agglomerator. If the comminuting tools which are arranged on the stator are adjusted in the axial direction toward the rotor, for example, the comminuting tools are immersed in each case in the annular groove of the opposing holding ring. Due to the possibility of being able to be received in the respective opposing holding ring, the comminuting tools can be designed to be sufficiently long that a shearing action between the comminuting tools can be ensured over the entire gap width, even in the case of a large gap width of the outlet opening.

The invention is explained in more detail hereinafter by way of the purely schematic drawings, wherein individual design features of a specific exemplary embodiment of a system for agglomerating and comminuting recycled plastic are not limited to this exemplary embodiment but can also be implemented in other embodiments and/or in other combinations. In the drawings:

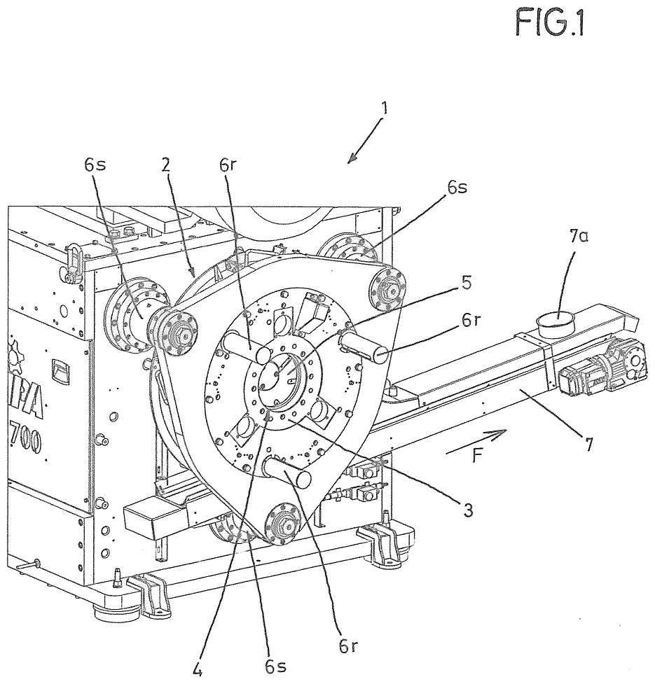

FIG. 1 shows a perspective view of a system for agglomerating and comminuting recycled plastic, comprising a first disk agglomerator,

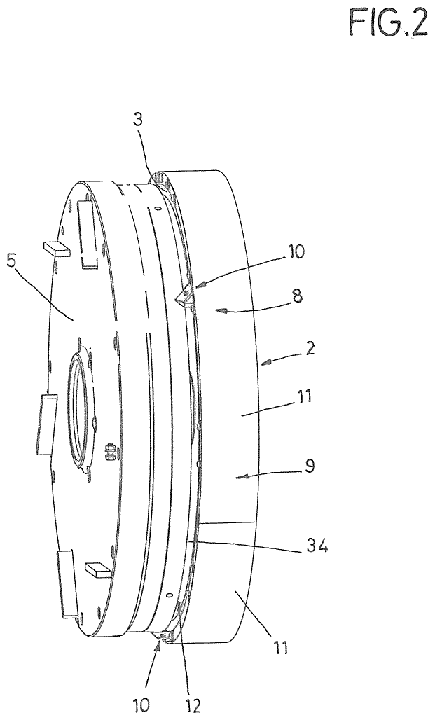

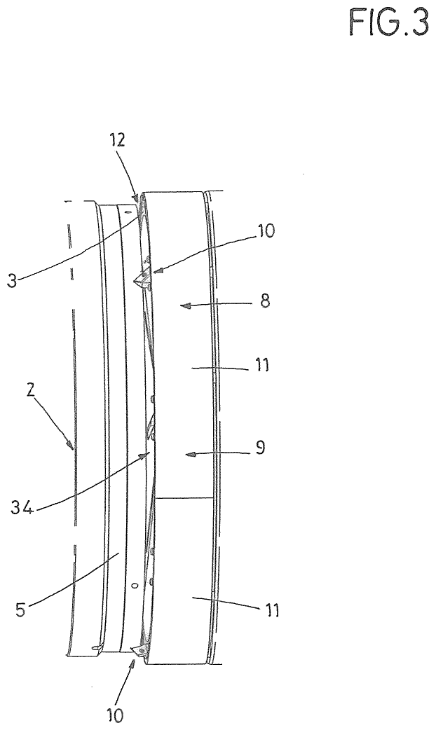

FIGS. 2 and 3 show views of a first ring comminutor in a normal position,

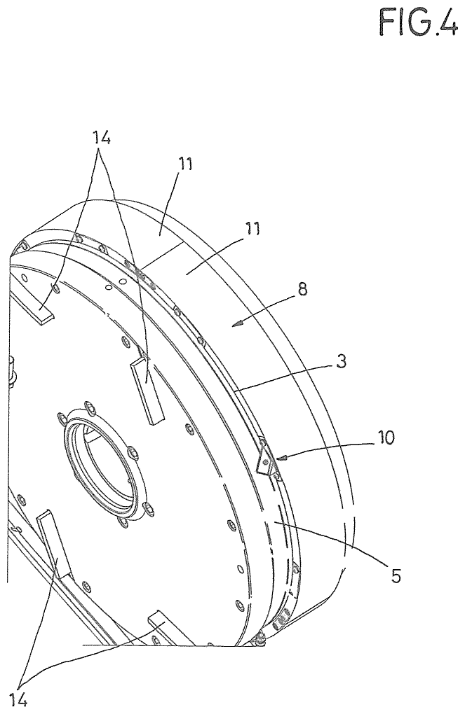

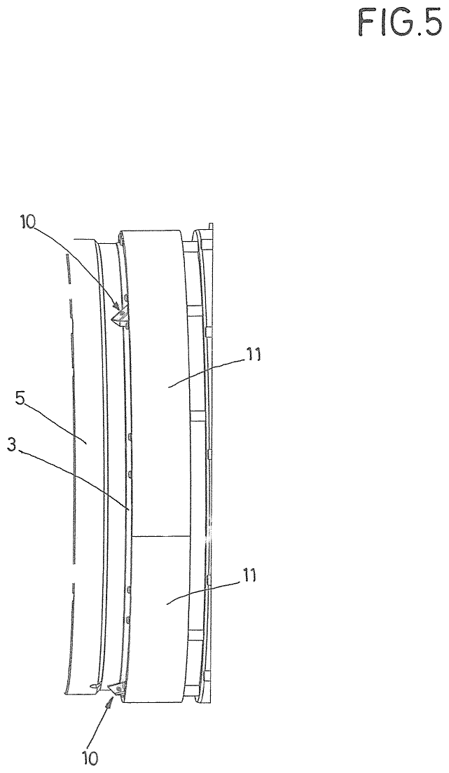

FIGS. 4 and 5 show views of the ring comminutor of FIGS. 2 and 3 in a start-up position,

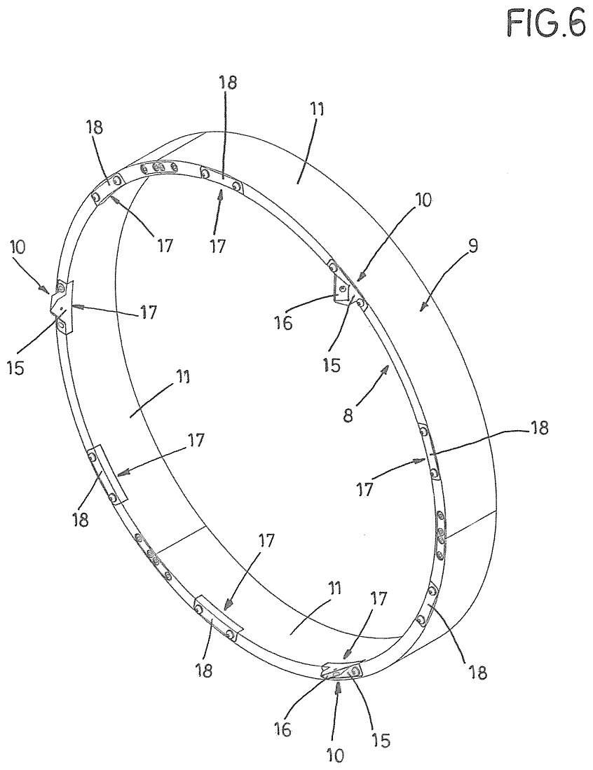

FIG. 6 shows a perspective view of a comminuting ring of the ring comminutor of FIGS. 2 to 5,

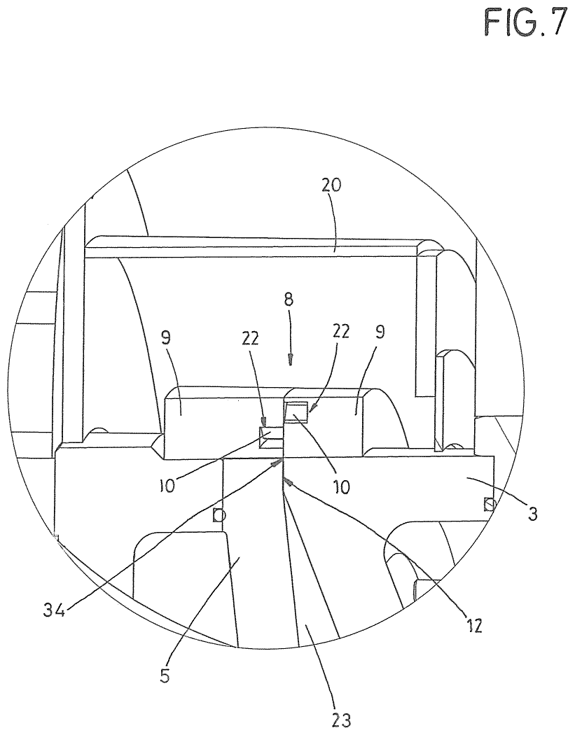

FIG. 7 shows a perspective view of a longitudinal section through a second ring comminutor in the start-up position,

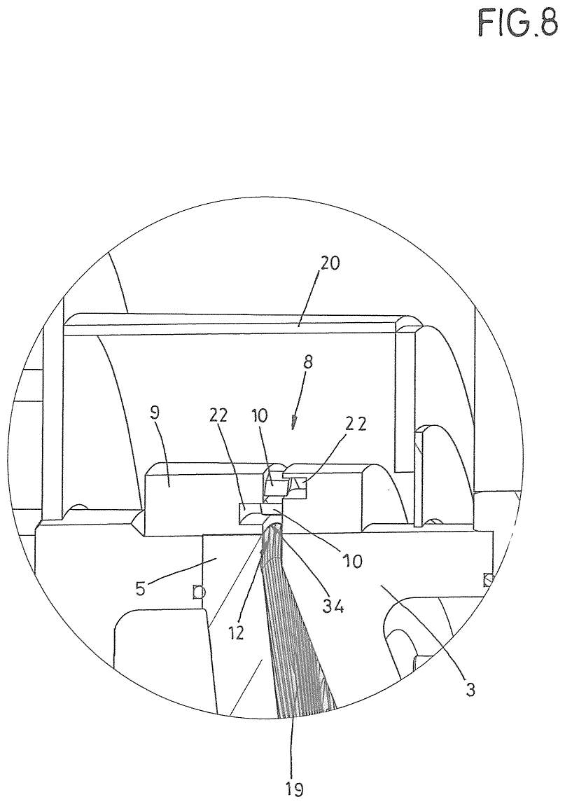

FIG. 8 shows a view of the ring comminutor of FIG. 7 in the normal position,

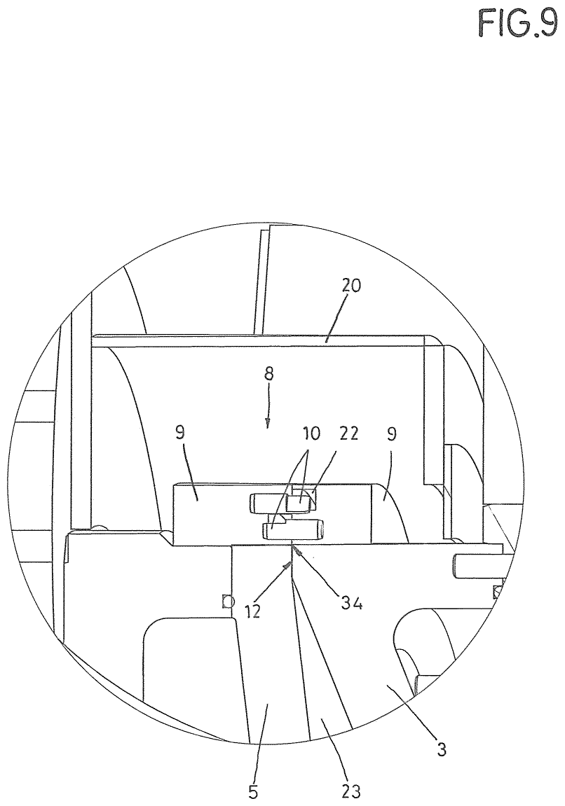

FIG. 9 shows a perspective view of a longitudinal section through a third ring comminutor in the start-up position,

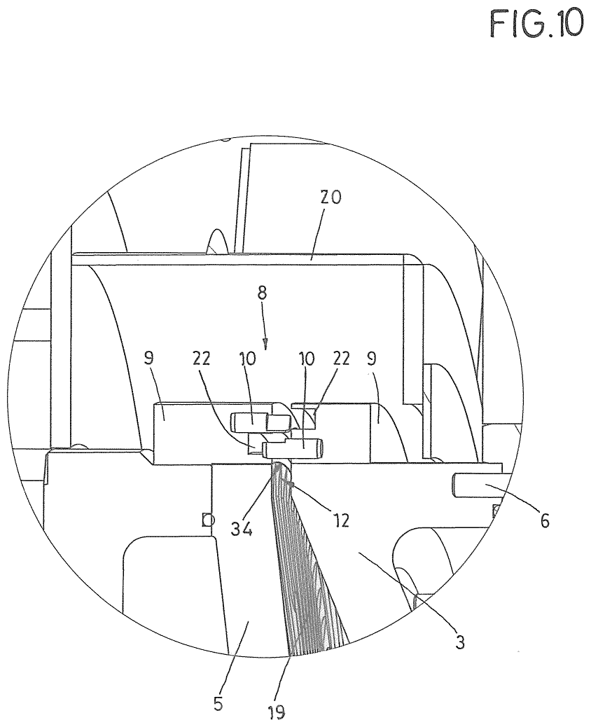

FIG. 10 shows a view of the ring comminutor of FIG. 9 in the normal position,

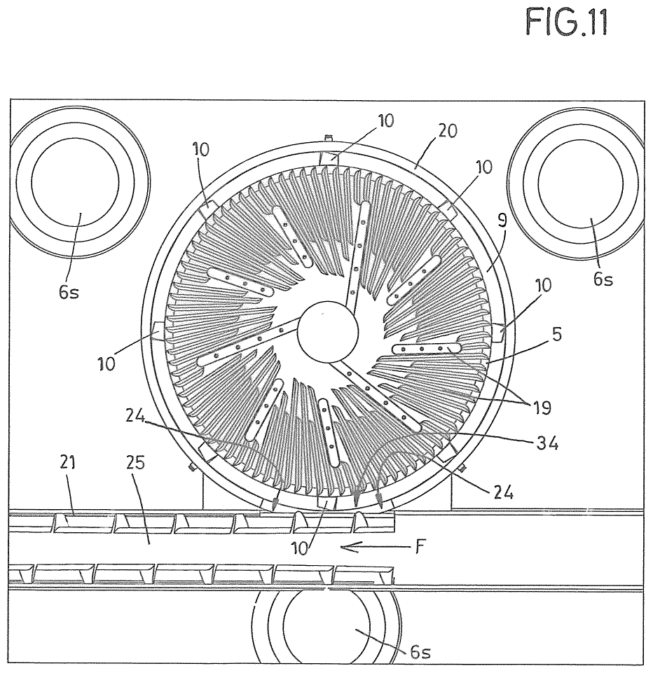

FIG. 11 shows a vertical cross section through a third disk agglomerator,

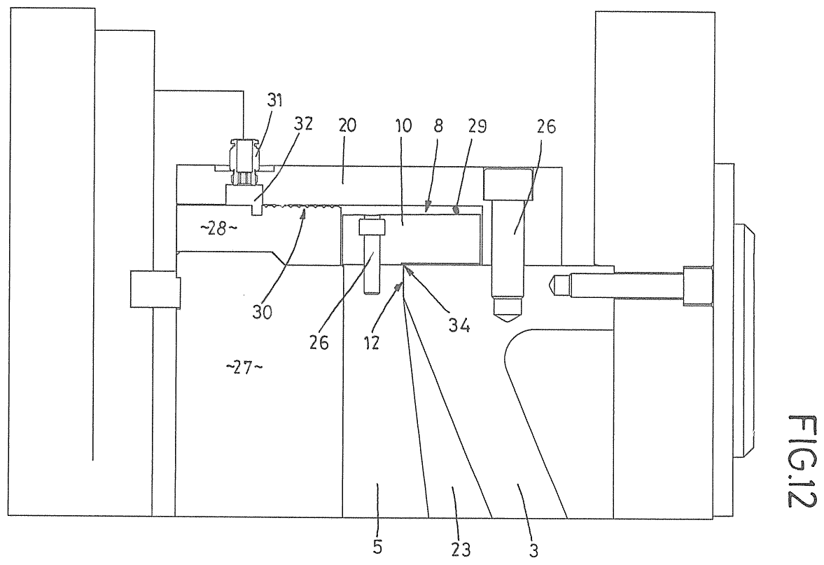

FIG. 12 shows a vertical longitudinal section through the upper region of the third exemplary embodiment in the start-up position,

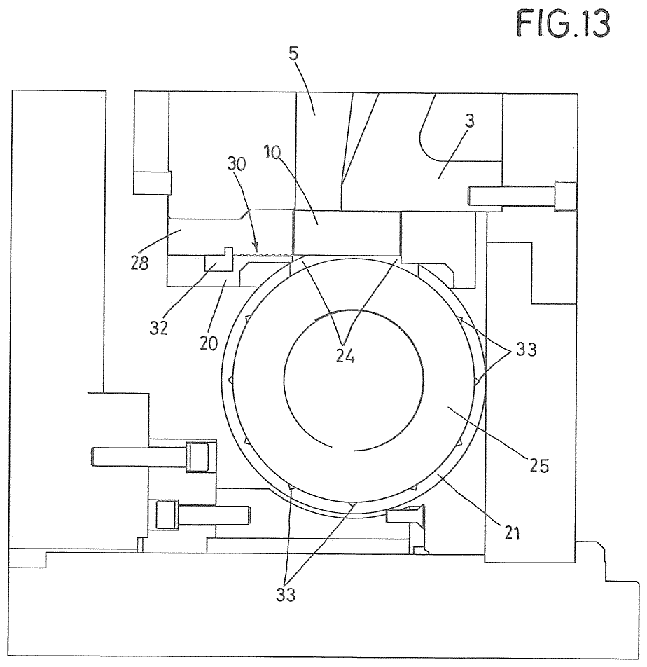

FIG. 13 shows a vertical longitudinal section through the lower region of the third exemplary embodiment in the start-up position, and

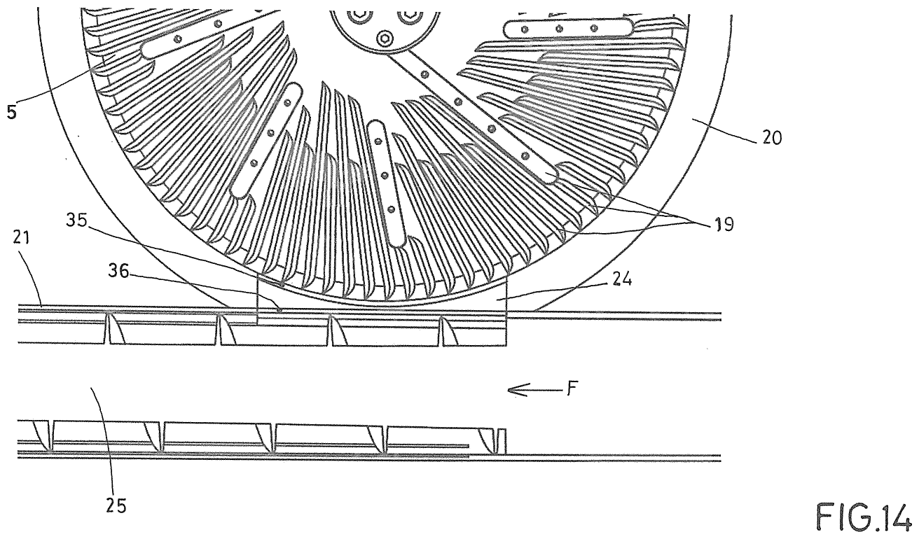

FIG. 14 shows a vertical cross section similar to FIG. 11 through a fourth disk agglomerator.

A system 1 for agglomerating and comminuting recycled plastic which has a disk agglomerator 2 is shown in FIG. 1. FIG. 1 shows, toward the observer, the rear face of a first disk of the disk agglomerator 2, denoted as the stator 3, with a central inlet opening 4 through which the recycled plastic is introduced into an intermediate area between the two disks. Through the inlet opening 4 the view is of a rotationally driven second disk of the disk agglomerator 2 denoted as the rotor 5. The stator 3 can be moved in the axial direction by means of three stator-actuating cylinders 6s so that the gap width between the stator 3 and the rotor 5 can be changed. A comminuting ring can be moved in the axial direction by means of three ring-actuating cylinders 6r which in each case have a substantially cylindrical protective cover, as is explained below in further detail. A housing 20 runs externally around the outer circumference of the stator 3 and the rotor 5.

In the lower circumferential region of the two disks of the disk agglomerator 2, a conveying device 7 is adjoined to the disk agglomerator 2 so that the agglomerates generated in the disk agglomerator 2 can be transported by means of the conveying device 7 in a conveying direction F to a downstream device in which the agglomerates are not only temporarily stored but are further processed. A suction connection 7a serves to remove from the agglomerate stream gases produced during the agglomeration, so that an undesired entry of gas, for example into a downstream extruder, can be reduced as far as possible.

FIGS. 2 and 3 show in each case the central constituent parts of a disk agglomerator 2, namely the rotor 5 which can be connected to a drive shaft and the stator 3 which is covered to a large extent by a ring comminutor 8. The ring comminutor 8 consists of a comminuting ring 9 and a plurality 4 comminuting tools 10, wherein the comminuting ring 9 in turn is composed of three segments 11. The disk agglomerator 2 in FIGS. 2 and 3 is located in its normal position which it normally adopts during operation, namely with a certain distance between the stator 3 and the rotor 5 so that a circumferential gap 12 is produced between the two disks on the outer circumference of the disk agglomerator 2. In this normal position the gap 12 forms on its outer circumference an open outlet opening 34 circulating in an annular manner between the two disks of the disk agglomerator 2.

The comminuting ring 9, which is arranged radially outwardly on the lateral surface of the stator 3, can be moved by the three ring-actuating cylinders 6r in the axial direction and thus moved closer to the rotor 5 or moved away therefrom, even when the stator 3 maintains its position. As a result, the comminuting ring 9 can be moved into the working position visible in FIGS. 2 and 3, namely into a retracted position at a distance from the rotor 5 in which the outlet opening 34 is open so that the comminuting tools 10 of the ring comminutor 8 are arranged radially outside the circumferential gap 12 and the outlet opening 34. The elongated agglomerates emerging from the outlet opening 34 on the circumference of the gap 12 between the stator 3 and the rotor 5 are captured by the comminuting tools 10 and, assisted by the rotational movement of the rotor 5 and the oblique position of the comminuting tools 10 visible in FIGS. 2 and 3, comminuted with a pulling cut.

If the ring-actuating cylinders 6r are extended, the comminuting ring 9 of the ring comminutor 8 is pushed over the gap 12 and in this manner the outlet opening 34 is closed, which is denoted as the start-up position of the disk agglomerator 2 and causes the material located in the disk agglomerator 2 between the stator 3 and the rotor 5 not to be able to pass as rapidly radially outwardly from the outlet opening 34 when the disk agglomerator 2 is started up, but to be able to be held longer in the disk agglomerator 2 and mechanically treated. Even though a direct contact of the stationary and rotating constituent parts of the disk agglomerator 2 is avoided, due to the minimal opening width of the outlet opening 34 and the required directional change which the material has to take on its path radially outwardly, a type of labyrinth seal which sufficiently sealingly closes the outlet opening 34 from a practical point of view is produced by the comminuting ring 9 when it is moved into the start-up position.

The duration of the start-up process is shortened by closing the outlet opening 34 and the escape of insufficiently agglomerated material can be substantially or even completely avoided. Thus, deviating from the exemplary embodiment shown, it can also be provided to use the comminuting ring 9 without comminuting tools 10 so that in this case it can be denoted as the start-up ring, to which only the closing function is assigned in order to close the outlet opening 34 when the disk agglomerator 2 is started up.

FIGS. 4 and 5 show the central constituent parts of the disk agglomerator 2 of FIGS. 2 and 3, but in a so-called start-up position in which the two disks are at a smaller distance from one another so that practically no gap 12 is produced between the stator 3 and the rotor 5. I. particular, it can be seen from FIG. 4 that the rotor 5 is provided with a number of deflectors 14 which serve to convey radially outwardly the recycled plastic which has passed behind the rotor 5 in the agglomerated state or even in the non-agglomerated state and not to allow the recycled plastic to pass to the drive shaft of the disk agglomerator 2.

FIG. 6 shows the ring comminutor 8 separately from the remaining constituent parts of the disk agglomerator 2. The construction of the comminuting ring 9 consisting of three segments 11 can be identified. The comminuting tools 10 have in each case a holder 15 and a blade 16 replaceably arranged therein. The cutting edges of the blades 16 are oriented in each case at an angle of approximately 45° to the axis of the disk agglomerator 2, so that a pulling cut is achieved when the agglomerates emerging from the gap 12 are guided in the rotational direction toward the blades 16 due to the rotational movement of the rotor 5. As the agglomerates are entrained by the rotor 5 in the rotational direction, the rotor 5 also provides the cutting energy required for the cutting.

The holders 15 are fixed to the segments 11 so as to be adjustable in the radial direction by means of slots, so that it is possible to set the radial distance at which the blades 16 are located upstream of the gap 12. Each segment 11 has three so-called receivers 17, namely the mounting positions for comminuting tools 10, and thus provides the possibility that in each case three comminuting tools 10 can be mounted on one segment 11. In the exemplary embodiment shown, only one comminuting tool 10 is shown per segment 11 while the two remaining respective receivers 17 are respectively protected by means of a cover element 18 against contamination and against the ingress of plastic in order to permit a simple mounting of a comminuting tool 10 if required.

FIG. 7 shows in section the upper circumferential region of the disk agglomerator 2. The stator 3 and the rotor 5 can be seen inside the housing 20. Similar to the exemplary embodiment of FIGS. 4 and 5, the exemplary embodiment of FIG. 7 is also in its start-up position. In the exemplary embodiment of FIG. 7, the start-up position is reached by an axial displacement of the stator 3 by means of the disk-actuating cylinders 6s, so that the gap 12 on the outer circumference of the two disks is closed by the stator 3 having been adjusted axially as far as the rotor 5. Accordingly, the two comminuting rings 9 of the ring comminutor 8 bear against one another. Both comminuting rings 9 are provided in each case on their front faces, which are oriented toward one another, with a circumferential annular groove 22 which serves to receive the comminuting tools 10 of the respective opposing comminuting ring 9. A disk intermediate area 23 tapers as far as a gap 12 and, in the start-up position shown, both the gap 12 and the outlet opening 34 on the outer circumference thereof are considered to be practically closed even when the stationary and the rotating constituent parts of the disk agglomerator 2 are not in contact but rather are at a minimal distance from one another.

As the gap 12 is fully open as in FIG. 7, or potentially slightly open deviating from the exemplary embodiment of FIG. 7, the recycled plastic is held in the disk intermediate area during the commissioning of the disk agglomerator 2, i.e. during the “start-up” thereof. Losses in the form of recycled plastic which is insufficiently agglomerated, and thus not suitable for further processing, can be reduced or even entirely avoided in this manner. The stator 3 is moved away from the rotor 5 by means of the actuating cylinders 6r and the gap 12 is opened to a sufficient extent that agglomerates can emerge therefrom and pass into the ring comminutor 8 only when the material which has passed into the disk intermediate area during start-up is sufficiently agglomerated between the stator 3 and the rotor 5.

FIG. 8 shows the exemplary embodiment of FIG. 7 after starting up the disk agglomerator 2 when it adopts its normal position and the disk intermediate area has been increased and the gap 12 and the outlet opening 34 have been opened by the adjustment of the stator 3. It can be identified how the comminuting tools 10 arranged at different radii cooperate to produce a shearing effect and have moved out of the annular groove 22 of the respectively opposing comminuting ring 9.

FIG. 9 shows the situation similar to FIG. 7, wherein in FIG. 9 a disk intermediate area 23 between the stator 3 and rotor 5 is closed on the outer circumference by means of a disk-actuating cylinder 6s since the disk agglomerator 2, shown in FIG. 9, is in its start-up position. In this exemplary embodiment, the comminuting tools 10 are shown as cylindrical pins which, outside their respective comminuting ring 9, have a cutting surface or oblique surface which has a comminuting effect.

FIG. 10 shows a situation similar to FIG. 8 for the exemplary embodiment of FIG. 9, in which the gap 12 is opened by a corresponding adjustment of the stator 3 and the disk agglomerator 2 adopts its normal position.

FIG. 11 shows a view of a further exemplary embodiment of a disk agglomerator 2 and of the rotor 5 thereof, with kneading bars 19 on the rotor 5. The housing 20 runs at a short distance around the two disks of the disk agglomerator 2. A ring comminutor 8 is designed such that it cooperates with the housing 20. The ring comminutor 8 has a plurality of comminuting tools 10 which are arranged on a comminuting ring 9 and in this manner form a comminuting ring. Deviating from the exemplary embodiment shown, the comminuting tools 10 can be arranged on the circumference of the rotor 5 and fastened thereto so that they are located on a circle and form a comminuting ring without it being designed as a ring which is physically present.

In the exemplary embodiment of FIG. 11, the elongated agglomerates emerging from the gap 12 are initially conveyed inside the housing 20 by means of the comminuting tools 10. In contrast to the deflectors 14 of FIG. 4, the comminuting tools 10 in FIG. 11 are not arranged on the rear face of the rotor 5 but radially outwardly adjoin the external circumference of the rotor 5 and also serve, similar to the deflectors 14 in FIG. 4, to clear the space inside the housing 20 into which plastic material passes and to transport the captured material.

The captured material is conveyed by means of the comminuting tools 10 inside the housing 20 to a housing opening 24 which forms the outlet opening 34 of the disk agglomerator 2. A shearing action for comminuting the agglomerates does not take place here by means of a second comminuting ring but rather in cooperation with the edge of the housing 20 which surrounds the housing opening 24. The elongated agglomerates are also not comminuted into separate shorter pieces but are completely filled into the space adjoining the housing opening 24 and comminuted in this manner. To this end, the comminuting tools 10 have a front face which acts on the material and which deviates at a suitable angle to the rear from a purely radial orientation. This achieves a filling action by which the material is introduced into a conveyor line 21 which directly adjoins the housing 20 in the exemplary embodiment shown.

The conveyor line 21 of FIG. 11 has a screw conveyor 25 which transports the material in the conveying direction F. In order to ensure an effective filling of the conveying screw 25, in this exemplary embodiment the conveying direction F runs counter to the direction in which the rotor 5 moves in the region of the housing opening 24. The conveyor line 21 can be, for example, the feeder screw of an extruder or a short-sized transfer screw which in turn adjoins an extruder screw. In both cases the temperature losses of the material can be respectively kept as small as possible so that in a particularly advantageous embodiment of the system 1 in terms of energy, the plastic material which has been initially agglomerated and then comminuted into smaller pieces can be further processed in an extruder which is on the shortest possible path downstream of the disk agglomerator 2.

The conveyor line 21 has an opening where it adjoins the housing 20 of the disk agglomerator 2. Deviating from the exemplary embodiment shown, a closure element can be arranged between the housing 20 and the conveyor line 21, for example in the form of a slide arranged on the housing 20 or on the conveyor line 21. Similar to the possibility of closing the outlet opening 34 by means of an axially adjustable comminuting ring 9 or an axially adjustable stator 3, in the start-up phase of the disk agglomerator 2 material can also be initially held by means of the closure element in the disk agglomerator 2 until the material is sufficiently agglomerated. Then the closure element, for example the aforementioned slide, is opened in order to allow the now sufficiently agglomerated material to pass from the housing 20 and into the conveyor line 21.

Moreover in the exemplary embodiment of FIG. 11 a suction connection, which is not shown, can be arranged in the region of the transition from the housing 20 to the conveyor line 21 in order to be able to suction off gases produced during the agglomeration before these gases can pass into the conveying screw 25.

A further development of the disk agglomerator 2 shown in FIG. 11 can consist in that the comminuting tools 10, which are similar to scrapers, are dispensed with. The housing 20 runs radially outwardly closely around the disks of the disk agglomerator 2. A distance which is as short as possible between the housing 20 and the disks is sufficiently great, on the one hand, that it ensures an operation of the disk agglomerator 2 without friction or malfunction, but is sufficiently small, on the other hand, that it prevents larger accumulations of the agglomerates passing radially outwardly between the disks. The pressure which is built up in the disk intermediate area 23 by the material which is conveyed into the disk agglomerator 2 and the centrifugal forces in the disk agglomerator 2 generated by the rotor 5, and the conveying action of the kneading bars 19, cause the agglomerates to be urged radially outwardly.

FIG. 12 shows a section through the upper region of the disk agglomerator 2 of FIG. 11, which is in its start-up position so that the gap 12 and the outlet opening 34 on the outer circumference of the disk intermediate area 23 are closed. The section in FIG. 12 runs through a comminuting tool 10 of the ring comminutor 8. The housing 20 is fastened to the stator 3 and the comminuting tools 10 are fastened to the rotor 5 by means of different screws 26. A rotor receiver 27 which is provided on its outer circumference with a sealing ring 28 is shown behind the rotor 5.

The sealing ring 28 has a thread profile 30, namely a groove running in a helical manner, toward a space 29 which runs radially outside the gap 12 in an annular manner around the disks of the disk agglomerator 2 and on its radial outer face toward the housing 20. The pitch of this thread profile 30 runs in a manner adapted to the rotational direction of the rotor 5 such that material which has penetrated into the helical groove is conveyed back into the space 29.

Moreover, the penetration of plastic into the region of the thread profile 30 is counteracted by means of sealing air: the housing 20 is provided with an air connection 31 to which a compressed air line can be connected. The compressed air flows into a sealing air channel 32, which circulates in an annular manner, and passes therefrom into the region of the thread profile 30 so that between the sealing ring 28 and the housing 20 the thread profile forces material which is located therein back into the space 29.

FIG. 13 shows the lower circumferential region of the disk agglomerator 2 of FIGS. 11 and 12. The section runs in the longitudinal direction of the rotational axis about which the rotor 5 rotates and thus transversely to the conveying screw 25. On the inner face of the tubular housing of the conveyor line 21, the conveyor line 21 has a plurality of holding grooves 33 which have a wedge-shaped cross section in each case. The holding grooves serve to prevent the material, which has been introduced by means of the comminuting tools 10 through the housing opening 24 into the conveyor line 21, from rotating together with the conveying screw 25, so that it is possible to achieve by means of the conveying screw 25 a translational movement of the material inside the conveyor line 21 which is as effective as possible in terms of conveyance.

FIG. 14 shows, similar to the view of FIG. 12, the lower circumferential region of a further variant of a disk agglomerator 2. In this variant, no drive elements are provided on the outer circumference of the rotor 5. The conveying action, with which the agglomerates are introduced into the conveyor line 21, is based on the rotational movement of the rotor 5, the shape of the kneading bars 19 and the supply of material which is conveyed into the disk agglomerator 2. In order to hold the material for a sufficiently long time between the stator 3 and the rotor 5 when starting up the disk agglomerator 2, and to ensure a sufficient agglomeration, the housing 20 can be closed by means of a housing slide 35 and/or the conveyor line 21 can be closed by means of a screw slide 36. Purely by way of example, both slides are shown in FIG. 14 so that, for example, the housing slide 35 or the screw slide 36 can be selectively used as a function of the plastic material which is used and which is processed in the disk agglomerator 2. Deviating from FIG. 14, the disk agglomerator 2 can have only one of the two slides.

### Reference Signs

1 System
2 Disk agglomerator
3 Stator
4 Inlet opening
5 Rotor
6 6s=Stator-actuating cylinder
   6r=Ring-actuating cylinder
7 Conveying device
   7a=Suction connection
   F=Conveying direction
8 Ring comminutor
9 Comminuting ring
10 Comminuting tool
11 Segment
12 Gap
14 Deflector
15 Holder
16 Blade
17 Receiver
18 Cover element
19 Kneading bars
20 Housing
21 Conveyor line
22 Annular groove
23 Disk intermediate area
24 Housing opening
25 Screw conveyor
26 Screw
27 Rotor receiver
28 Sealing ring
29 Space
30 Thread profile
31 Air connection
32 Sealing air channel
33 Holding groove
34 Outlet opening
35 Housing slide
36 Screw slide

1: A system (1) for agglomerating and comminuting recycled plastic, comprising an agglomerator,
which is designed to receive plastic waste and form the same into elongated pin-shaped or sausage-shaped agglomerates in a pasty state,
and which is designed in the form of a disk agglomerator (2) comprising two disks,
which are profiled on the mutual facing surfaces thereof,
can be moved relative to each other,
are arranged parallel and at a distance to each other,
and form a disk intermediate area (23) between one another,
and which has an inlet opening (4) for the recycled plastic, said opening leading into the central region of the disk intermediate area (23),
and which has an outlet opening (34) for the agglomerates,
characterized in that
a housing (20) runs about the exterior of the disks of the disk agglomerator (2) in an annular manner and has a housing opening (24) which adjoins a conveyor line (21),
wherein a rotating disk of the disk agglomerator (2) is designed to have a conveying effect so as to act on the agglomerates and guide the same into the conveyor line (21) under pressure,
and in that the conveyor line (21) leads to a device for further processing the agglomerates.

2: The system as claimed in claim 1,
characterized in that
the outlet opening (34) is arranged on the outer circumference of the disk intermediate area (23) and a ring comminutor (8) has comminuting tools (10)
which are arranged radially outside the outlet opening (34).

3: The system as claimed in claim 1,
characterized in that
comminuting tools (10) extend radially inside the housing opening (24) into a space (29) between the housing (20) and the disks of the disk agglomerator (2) with a conveying effect such that the comminuting tools convey agglomerates located in this space to the housing opening (24).

4: The system as claimed in claim 1,
characterized in that
a rotating disk of the disk agglomerator (2) has conveying members.

5: The system as claimed in claim 4,
characterized in that
the comminuting tools (10) form the conveying members.

6: The system as claimed in claim 1,
characterized in that
the conveyor line (21) adjoining the disk agglomerator (2) has a screw conveyor (25).

7: The system as claimed in claim 6,
characterized in that
the conveyor line (21) is designed as an extruder screw or as a transfer screw which is connected to an extruder.
